(19) United States
(12) Patent Application Publication
(10) Pub. No.: US 2009/0116916 A1
(43) Pub. Date: May 7, 2009

(54) FINE ADJUSTING METHOD OF THE FEED AMOUNT OF THE BORING CUTTER AND THE ADJUSTING DEVICE THEREOF

(76) Inventor: Shoushan Qiu, Shanghai (CN)

Correspondence Address: ZHEN ZHENG LU, 1730 HUNTINGTON DRIVE #304, DUARTE, CA, 91010, US

(21) Appl. No.: 12/297,239

(22) PCT Filed: Apr. 16, 2007
(86) PCT No.: PCT/CN2007/001238

§ 371 Date: Oct. 15, 2008

(30) Foreign Application Priority Data
Apr. 18, 2006 (CN) 200610025812.7

(51) Int. Cl. B23B 51/00; B23C 1/20

(52) U.S. Cl. 408/158; 409/179

(57) ABSTRACT

A fine adjusting method of the feed amount of a boring cutter includes the following steps: a shank body rotates around its axes as the center of a circle to make the cutter tip rotate around its axes as the center of a circle which is apart away from the axes with an offset distance e therebetween so as to change the feed amount. An adjusting device which can achieve the fine adjusting method of the feed amount of the boring cutter includes: a shank body which has a tapered bore, and the axes of the tapered bore is apart away from the axes of the shank body; a rotating cone body which cooperates with the tapered hole; and the rotating cone body is provided with another tapered hole; a changeable cutter holder which is installed in the tapered hole of the rotating cone body; and a drive mechanism which mounts on the shank body and drives the rotating cone body to rotate, therefore makes the changeable cutter holder rotate so as to achieve the micro-feed of the cutter tip.

### BACKGROUND OF THE PRESENT INVENTION

1. Field of Invention

The present invention relates to a machining cutting tool, and more particularly to a method for adjusting feed amount of a cutter and an adjusting device thereof, and especially a method for adjusting feed amount of a boring cutter and an adjusting device thereof.

2. Description of Related Arts

As we all known, the current available fine adjusting boring cutter bar comprises a shank body having a linear guide track, a moving body engaged with the guide track, a screw stem transmission mechanism, a changeable cutter arbor, a dial for indicating linear feed amount, and a fastening screw, which is called a linear type fine adjusting boring cutter bar, as shown in FIG. 1. The moving body is driven by the screw stem transmission mechanism to move along the axis of the screw stem, so that the radial position of the moving body is changed to change the feed amount. In this structure, there are many elements that are hard to be manufactured and are difficult to cooperate with each other. Furthermore, there is a gap between the linear moving elements, so that the precision of the boring hole is affected, if without proper maintenance. In addition, when the moving body is moved for a long distance, the gravity center is shifted largely, so that quick cutting can not be realized. And the screw pitch cannot be small, so that the precision of fine adjustment is restricted. The precision of the fine adjustment of the imported product can be only up to 0.01 mm.

### SUMMARY OF THE PRESENT INVENTION

In order to overcome the above mentioned drawbacks, an object of the present invention is to provide a method for adjusting feed amount of a cutter. The method adopts the principle of the Archimedes spiral, wherein the cutter is pushed inwards in a rotary manner to satisfy the machining demand.

Another object of the present invention is to provide an adjusting device for adjusting feed amount of a cutter, so as to satisfy various work conditions of the boring hole of the hole machining machine.

Accordingly, in order to accomplish the above object, the present invention provides a method for fine adjusting feed amount of a boring cutter, wherein the cutter bar rotates with an axis of the cutter bar as center of circle for driving a cutter tip to rotate taking a center of circle that has an offset e apart from an axis of the cutter bar, so as to adjust a feed amount of the boring cutter.

The offset e is obtained by designing an Archimedes spiral taking an axis center of the cutter bar as center and replacing an Archimedes spiral with an approximate arch ^{α}, and the offset between a center of the arch ^{α} and the axis center of the cutter bar is e.

The offset e is a real number.

An adjusting device for adjusting feed amount of a boring cutter, comprising:

a cutter bar having a first taper hole therein with an axis that is apart from an axis of the cutter bar;

a rotating taper, engaged with the taper hole of the cutter bar, having a second taper hole provided therein; and

a driving mechanism mounted on the cutter bar and driving the rotating taper to drive a changeable cutter arbor to rotate so as to adjust feed amount of the cutter.

The driving mechanism is a turbine and worn transmission mechanism.

A dial for indicating feed amount of cutter changing in a rotary manner is provided on the worn of the turbine and worn transmission mechanism, so as to obtain accurate feed amount value.

As adopting the above technique, the boring cutter of the present invention has good linear character and high precision for fine adjusting the feed amount. The precision of the fine adjustment is up to 0.002 mm. The device has many advantages. For example, the elements of the device are simple in shape; the device has rigid structure, and is convenient to operate; due to small shift of the gravity center, the device can be used for quick cutting. The device can satisfy various work conditions of the hole machining machine, such as the boring machine, milling machine, and drilling machine.

These and other objectives, features, and advantages of the present invention will become apparent from the following detailed description, the accompanying drawings, and the appended claims.

### BRIEF DESCRIPTION OF THE DRAWINGS

FIG. 1 is a structural schematic view of a prior art of a linear fine adjusting boring cutter bar.

FIG. 2 is a schematic view of a method for adjusting feed amount of a boring cutter according to a preferred embodiment of the present invention, illustrating the principle of present invention.

FIG. 3 is a structural schematic view of a fine adjusting device for adjusting feed amount of a boring cutter of example 1 according to the above preferred embodiment of the present invention.

FIG. 4 is an A-A sectional view of FIG. 3.

FIG. 5 is a sectional view of B direction of FIG. 3.

FIG. 6 is a perspective view of a fine adjusting device for adjusting feed amount of a boring cutter of example 2 according to the above preferred embodiment of the present invention.

FIG. 7 is a side sectional view of the fine adjusting device for adjusting feed amount of a boring cutter of example 2 according to the above preferred embodiment of the present invention.

FIG. 8 is an A-A sectional view of FIG. 7.

FIG. 9 is a sectional view of B direction of FIG. 7.

FIG. 10 is a perspective view of a fine adjusting device for adjusting feed amount of a boring cutter of example 3 according to the above preferred embodiment of the present invention.

FIG. 11 is a perspective view of a fine adjusting device for adjusting feed amount of a boring cutter of example 4 according to the above preferred embodiment of the present invention.

FIG. 12 is a perspective view of a fine adjusting device for adjusting feed amount of a boring cutter of example 5 according to the above preferred embodiment of the present invention.

FIG. 13 is a side sectional view of the fine adjusting device for adjusting feed amount of a boring cutter of example 5 according to the above preferred embodiment of the present invention.

FIG. 14 is an A-A sectional view of FIG. 13.

FIG. 15 is a perspective view of a fine adjusting device for adjusting feed amount of a boring cutter of example 6 according to the above preferred embodiment of the present invention.

FIG. 16 is a perspective view of a fine adjusting device for adjusting feed amount of a boring cutter of example 7 according to the above preferred embodiment of the present invention.

### DETAILED DESCRIPTION OF THE PREFERRED EMBODIMENT

Referring to FIG. 1 of the drawings, a currently available linear fine adjusting boring cutter bar according to a preferred embodiment of the present invention is illustrated, in which the fine adjusting boring cutter bar comprises a shank body 1′ having a linear guide track, a moving body 2′ engaged with the guide track, a screw stem transmission mechanism 3′, a changeable cutter arbor 4′, a dial 5′ for indicating linear feed amount, a cutter 6′ and a fastening screw 7′.

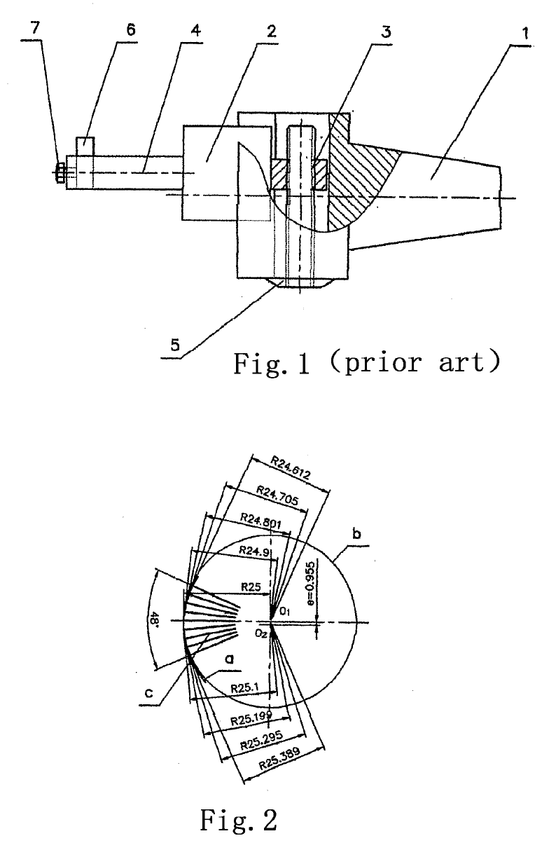

Referring to FIG. 2 of the drawings, a method for adjusting feed amount of a boring cutter is illustrated. An Archimedes spiral taking the axis center O₁ of the cutter bar as center is designed, and mathematically processed. In a proper angle, such as 48 degree, replace the Archimedes spiral with an approximate arch α. The offset between the center of the arch αO₂ and the cutter bar axis center O₁ is e, which is a real number. When the cutter tip rotates around the center of arch α O₂, the feed amount of the cutter is adjusted. The linear character of this method is good. When the dial for indicating the feed amount of the cutter is equally divided to 50 parts, the error of each part is less than 0.0005 mm. The arch b is machining circle, and the lines c indicate the position of cutter during rotating process.

### EXAMPLE 1

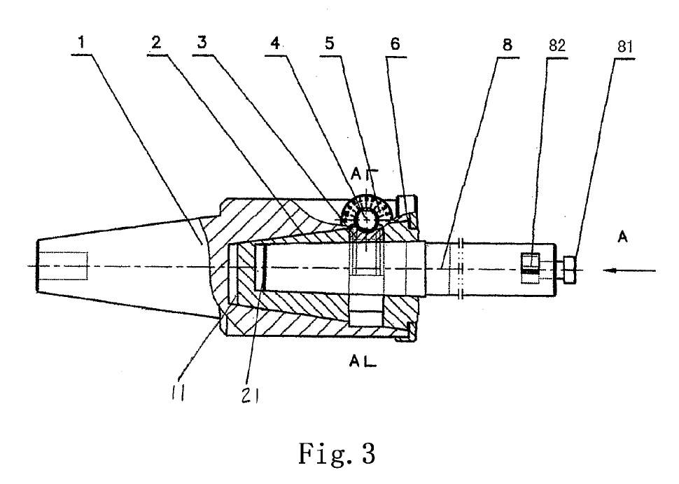

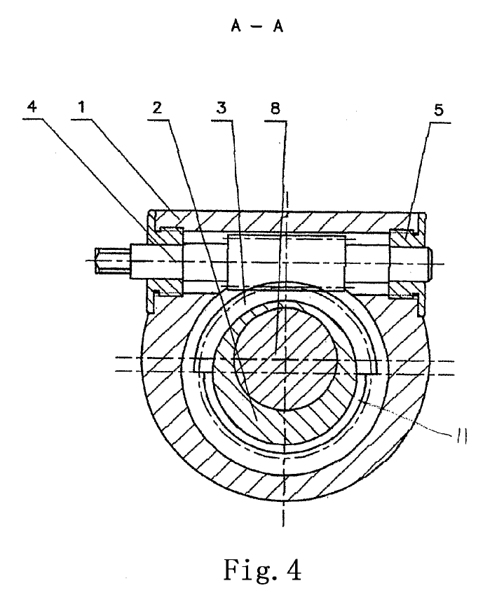

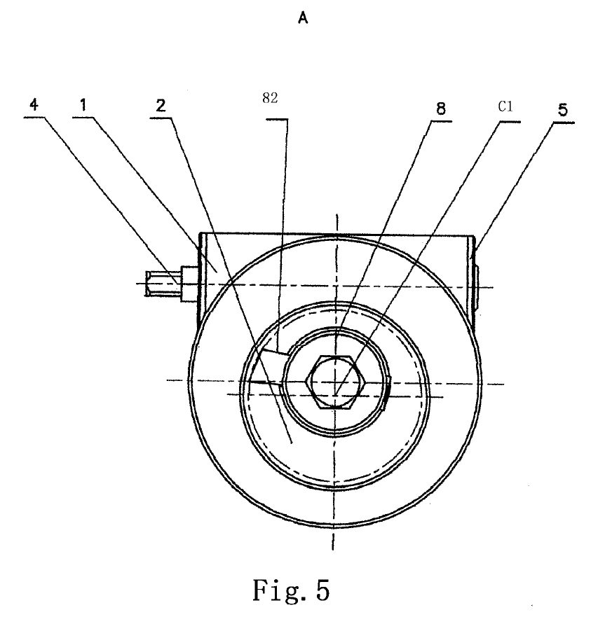

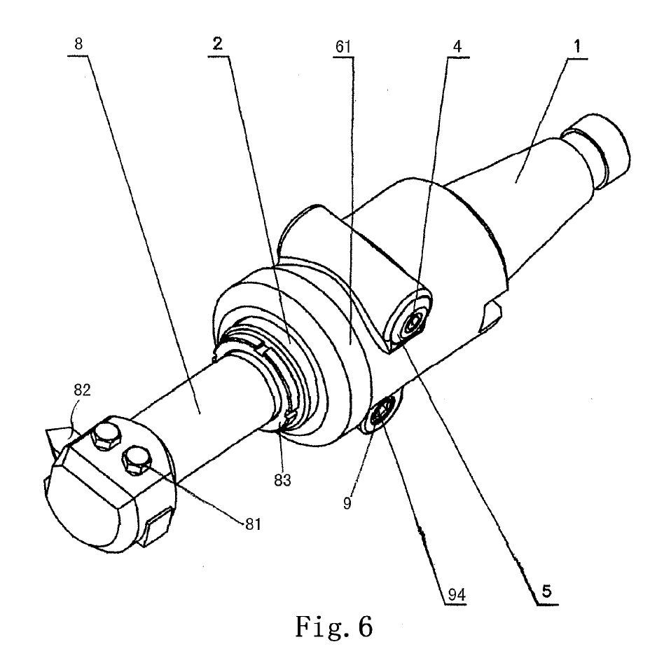

Referring to FIG. 3, FIG. 4 and FIG. 5 of the drawings, the fine adjusting device for adjusting feed amount of a cutter is applied to milling machine. The taper shank of the cutter bar 1 is engaged into the taper hole of the main shaft of the milling machine. The cutter bar 1 has a first eccentric taper hole 11 apart from the axis of the cutter bar 1. In the first eccentric taper hole 11, a rotating taper 2 is provided between a side cover threadedly connected to the cutter bar 1 and a resilient element 6. The rotating taper 2 also has a second eccentric hole 21 apart from the axis of the rotating taper 2. A changeable cutter arbor 8 is provided in the second eccentric hole 21 of the rotating taper 2. A cutter 81 is mounted on the front of the changeable cutter arbor 8 via a fastening screw 81.

A turbine 3 is mounted on the rotating taper 2, and it also can be directly incorporated onto the outer surface of the rotating taper. A worn 4 is mounted on the cutter bar 1 via a pair of bearing side covers 5, and is engaged with the turbine 3 so as to drive the rotating taper 2 to rotate. The bearing side cover 5 on one side of the worn has 20 indicating lines marked thereon, and each indicating line indicates that the feed amount changes 0.025 mm. That is to say, when the worn 4 rotates one circle, the feed amount changes 0.5 mm. While fine adjusting, rotate the worn 4, so that the turbine 3 drives the rotating taper 2 to rotate due to the engagement between the worn 4 and turbine 3, and further drives the changeable cutter arbor 8 to rotate, so as to fine adjust the cutter tip of the cutter 82.

In order to improve the accuracy of indicating lines, the line between the cutter tip of the cutter 82 and the center of the cutter bar 1 is visually vertical to the line between the first eccentric taper hole 11 and the second eccentric taper hole 12. As shown in FIG. 5, the exclusive bar for rotating the worn 4 is put on while fine adjusting, and is taken off while boring.

This example can also be applied to a boring machine and a drilling machine. The difference is the taper of the taper shank of the cutter bar, because the taper shank has to engage into the taper hole of the main shaft of the boring machine and drilling machine. Other structures are same with the above mentioned structures.

Adopting the principle and structure of the example, a series of products can be manufactured by changing the transmission ratio of the transmission structure of the turbine and worn, eccentric offset, or the taper shank of the cutter bar 1 for being applied to the boring machine, milling machine, and drilling machine and other hole machining machines.

### EXAMPLE 2

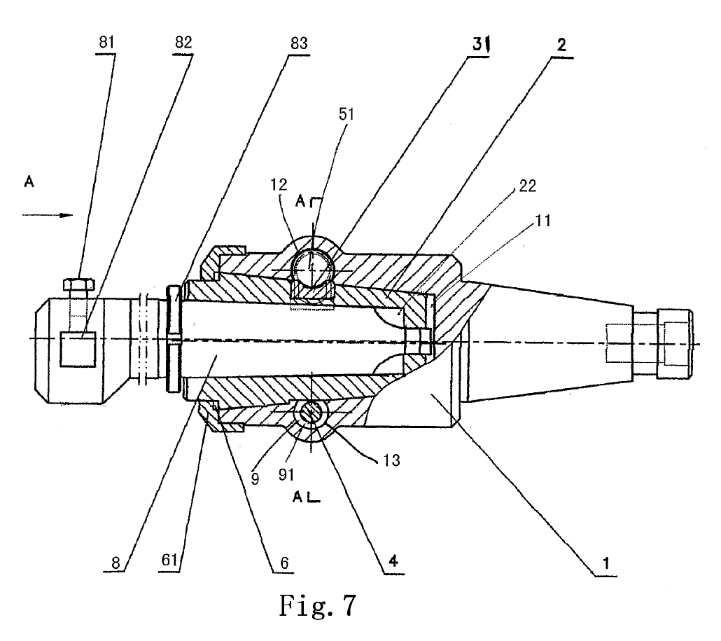

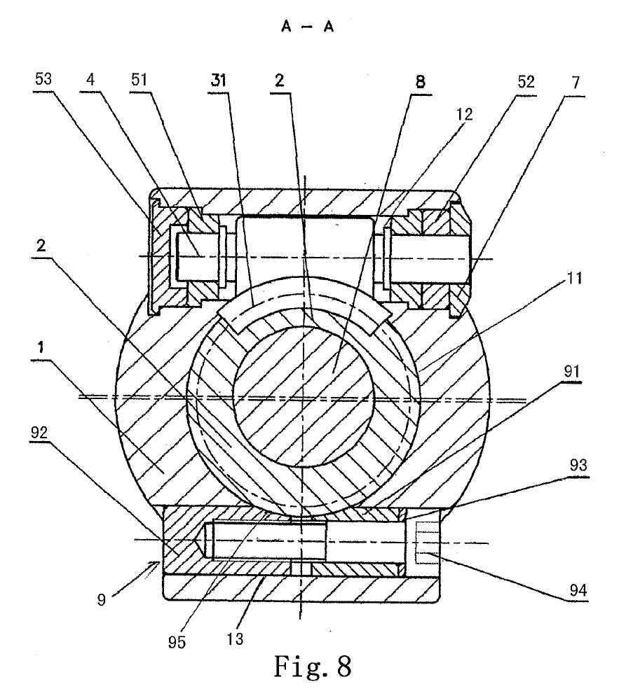

Referring to FIG. 6 through FIG. 9, the fine adjusting device for adjusting feed amount of a cutter is applied to a milling machine. The taper shank of the cutter bar 1 is engaged into the taper hole of the main shaft of the milling machine.

In this example, when the worn 4 rotates one circle, the feed amount change 0.5 mm. The dial 7 for indicating feed amount on the worn 4 has 50 indicating lines marked thereon, and each indicating line indicates that the feed amount changes 0.01 mm.

In the eccentric taper hole 11 of the cutter bar 1, the rotating taper 2 having a taper hole 22 therein is mounted between the resilient element 6 and a fastening cover 61 that is threadedly connected with the cutter bar 1. The axis of the taper hole 22 is coincidence with the axis of the rotating taper.

An incomplete turbine 31 of the turbine and worn mechanism is mounted on the rotating taper 2. The two sides of the worn is mounted in the worn hole 12 of the cutter bar 1 via a bearing 51, a bearing fastener 52 and a bearing fastener with cover 53. The worn 4 is engaged with the incomplete turbine 31.

A dial for indicating feed amount 7 is fixed on one side of the worn 4 and can rotate with the worn 4.

A first fastener 91 and a second fastener 92 of a fastening unit 9 are fastened in the fastening hole 13 of the cutter bar via a gasket 93 and a fastening bolt 94. A fastening arch 95 matched with the outer taper arch of the rotating taper 2 is provided on the first fastener 91 and the second fastener 92 respectively. When the fastening bolt 94 is fastened, the first fastener 91 and the second fastener 92 are close to each other, so that the fastening arches 95 on the first fastener 91 and the second fastener 92 contacts and rotates the outer surface of the rotating taper 2, so as to fasten the rotating taper. When the fastening bolt 94 is loosened, the first fastener 91 and the second fastener 92 are apart from each other, so that the fastening arches 95 on the first fastener 91 and the second fastener 92 is separated from the outer surface of the rotating taper 2. The rotating taper 2 is driven to rotate by the worn 4 and the incomplete turbine 31.

The changeable cutter arbor 8 is mounted in the taper hole 22 of the rotating taper 2 via a screw 83, and the cutter 82 is mounted on the changeable cutter arbor 8 via a fastening bolt 81.

While fine adjusting, rotate the incomplete turbine 31 engaged with the worn 4 to drive the rotating taper, and further to drive the changeable cutter arbor 8 to rotate, so as to fine adjust the cutter 82.

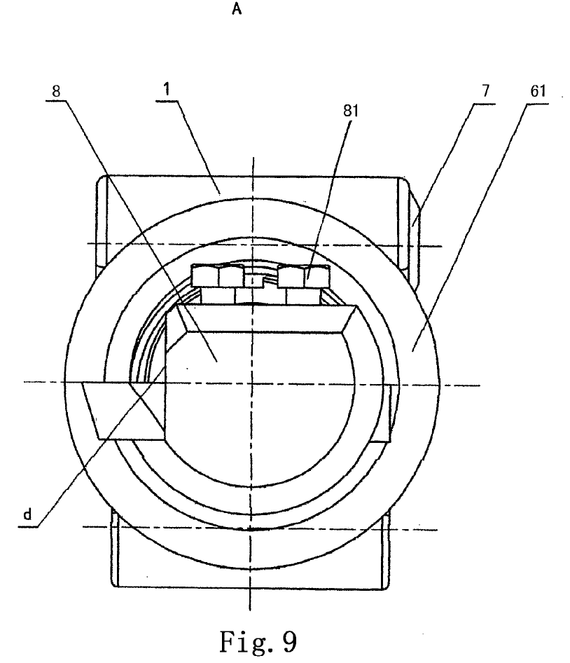

Due to the small range of the fine adjustment, large position shift can be achieved by adjusting the position of the cutter and a plurality of changeable cutter arbor 8 of different sizes (30 mm-120 mm). The cutter 82 is mounted according to the reference surface d, which is very convenient and precise, as shown in FIG. 9.

The shank of the changeable cutter arbor 8 adopts the taper of 1:20, and comprises a rotation proof flat tenon.

### EXAMPLE 3

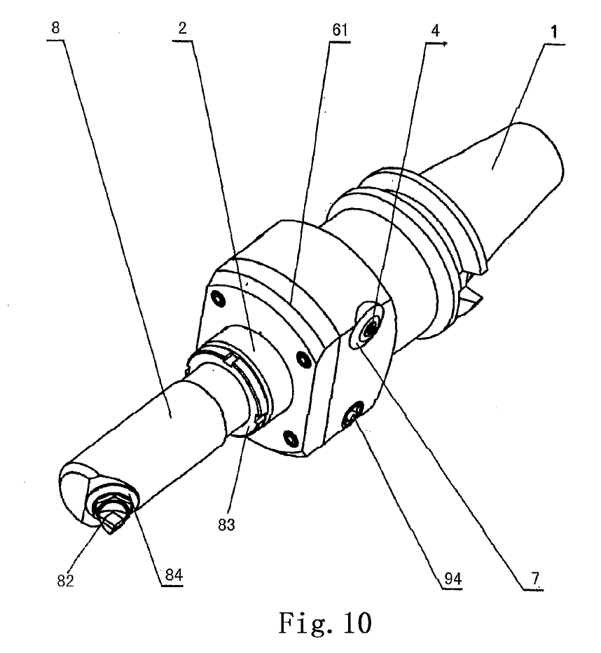

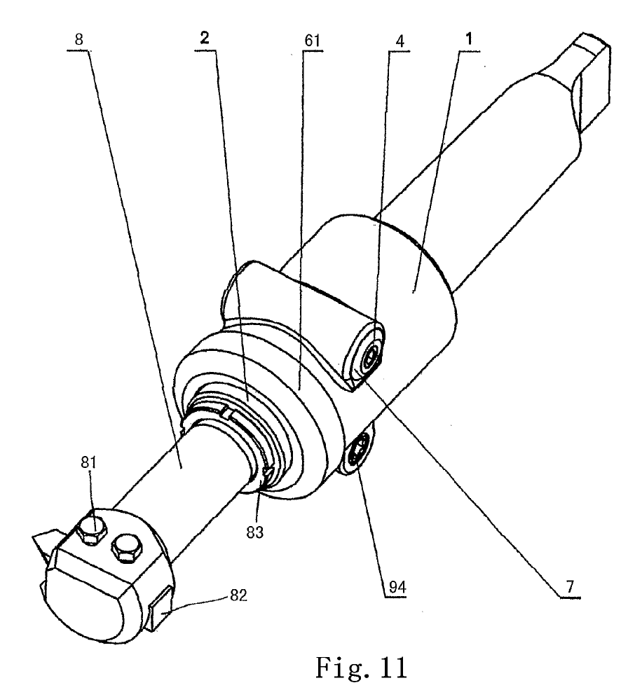

The example 3 is applied to a machining center machine. As shown in FIG. 10, the difference from the example 2 is that the taper shank of the cutter bar is engaged with the taper hole of the axis of the machining center (ISO 7:24 50); and both linear and rotation way to change the feed amount are adopted.

The cutter 82 is threadedly connected with the changeable cutter arbor 8. A dial for indicating linear feed amount 84 is provided at the threaded connection position of the changeable cutter arbor 8. The cutter 82 has indicating lines stamped thereon.

The changeable cutter arbor 8 adjusts the feed amount via the thread thereon. The angle between the axis of the thread and the axis of the changeable cutter arbor 8 is 53 degree and 8 minute. The thread pitch is 1 mm. The dial for indicating linear feed amount 84 is equally divided to 20 parts, and the indicating precision is 0.04 mm.

Changing the feed amount in a rotary manner is adopted on the cutter bar 1. The incomplete turbine 31 rotates for one tooth, the feed amount changes for 0.1 mm. The dial 7 for indicating feed amount is equally divided to 50 parts, each part indicates that the feed amount changes 0.002 mm. The principle and structure of the feed amount change in a rotary manner is similar to the example 2.

### EXAMPLE 4

Example 4 is applied to a drilling and boring machine. As shown in FIG. 11, the structure of the cutter bar 1 is different from the example 3. The taper shank of the cutter bar 1 is engaged with the taper hole at the main axis of the drilling and boring machine (morse taper). The principle and structure of the feed amount change in a rotary manner is similar to the example 3.

### EXAMPLE 5

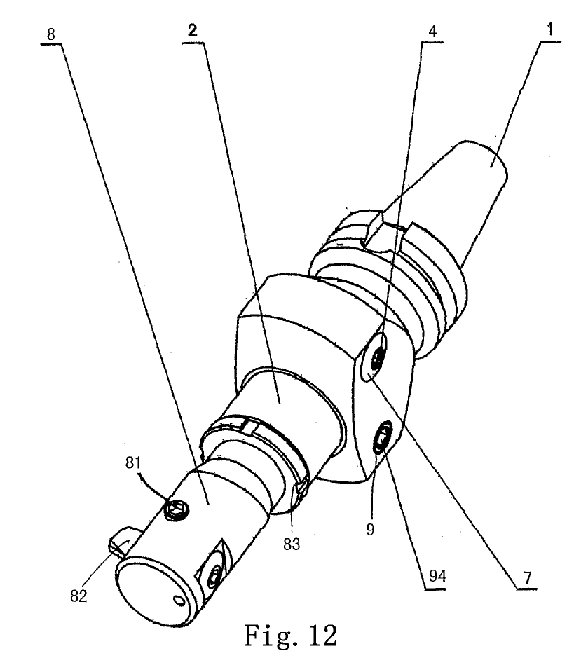

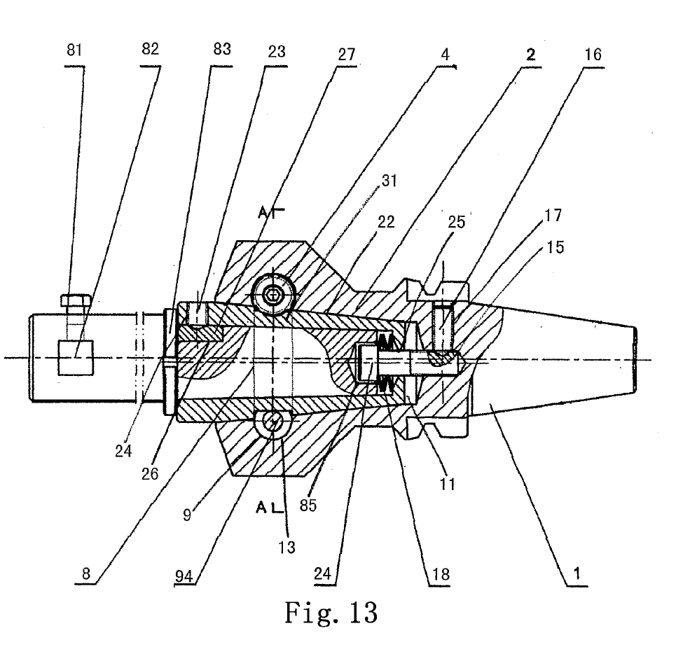

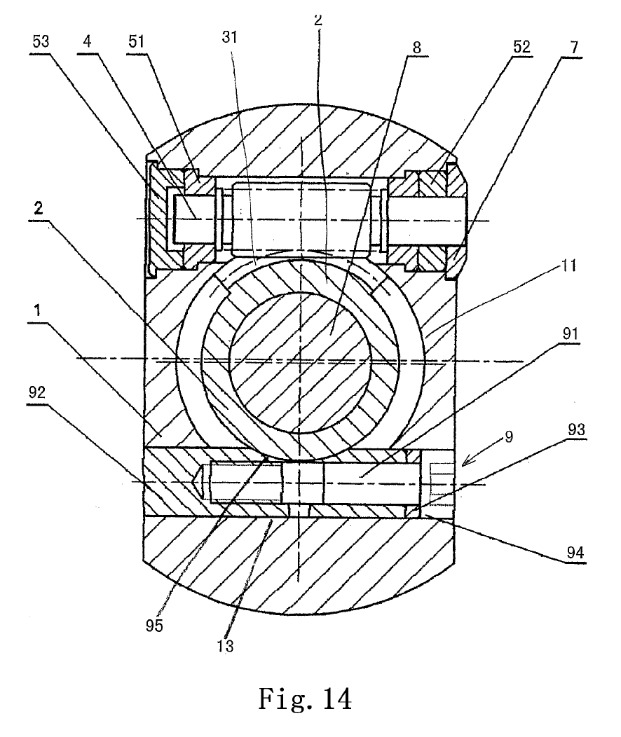

Referring to FIG. 12 through FIG. 14, this example is applied to a machining center machine. The perspective view is shown in FIG. 12. The taper shank of the cutter bar is engaged with the taper hole of the axis of the machining center machine (ISO 7:24 50).

An eccentric hole 11 is provided in the cutter bar 1, wherein the axis of the eccentric hole is apart from the axis of the cutter bar. A pressure adjusting screw hole 15 for mounting pressure adjusting screw 14 and a fastening screw hole 17 for mounting fastening screw 16 are respectively provided on the cutter bar 1. An incomplete turbine 31, a taper hole 22 for mounting changeable cutter arbor 8, an optical hole 25 for receiving pressure adjusting screw 14, and a fastening screw hole for mounting fastening screw 23 are provided on the rotating taper 2 that is engaged with the eccentric taper hole 11. A screw head hole 85 for receiving the head of the pressure adjusting crew 14 is provided at the end of the changeable cutter arbor 8.

The two sides of the worn of the turbine and worn mechanism is mounted in the worn hole 12 of the cutter bar 1 via a bearing 51, a bearing fastener 52 and a bearing fastener with cover 53. The worn 4 is engaged with the incomplete turbine 31.

A dial for indicating feed amount 7 is fixed on one side of the worn 4 and can rotate with the worn 4.

A first fastener 91 and a second fastener 92 of a fastening unit 9 are fastened in the fastening hole 13 of the cutter bar via a gasket 93 and a fastening bolt 94. A fastening arch 95 matched with the outer taper arch of the rotating taper 2 is provided on the first fastener 91 and the second fastener 92 respectively. When the fastening bolt 94 is fastened, the first fastener 91 and the second fastener 92 are close to each other, so that the fastening arches 95 on the first fastener 91 and the second fastener 92 contacts and rotates the outer surface of the rotating taper 2, so as to fasten the rotating taper. When the fastening bolt 94 is loosened, the first fastener 91 and the second fastener 92 are apart from each other, so that the fastening arches 95 on the first fastener 91 and the second fastener 92 is separated from the outer surface of the rotating taper 2. The rotating taper 2 is driven to rotate by the worn 4 and the incomplete turbine 31.

The changeable cutter arbor 8 is mounted in the taper hole 22 of the rotating taper 2 via a screw 83, and the cutter 82 is mounted on the changeable cutter arbor 8 via a fastening bolt 81.

A disk spring unit comprises a disk spring 18, a pressure adjusting screw 14, and a fastening screw 16 that is mounted on the bottom of the taper hole 22 of the rotating taper 2. The head of the pressure adjusting screw 14 is inserted into the head hole 85 of the changeable cutter arbor 8. The threaded segment passes through the disk spring 18 and the optical hole 25 at the bottom of the rotating taper 2 and is being inserted into the pressure adjusting screw hole 15 of the cutter bar 1. Press the disk spring 18 tightly, so as to keep the rotating taper 2 rotating inside the cutter bar 1 without shifting the axis of the rotating taper. Fasten the fastening screw 16 in the fastening screw 17 of the cutter bar 1, and press the pressure adjusting screw 14 so as to prevent the pressure adjusting screw 14 from loose.

A flat key slot 26 is provided on the rotating taper 2, and a flat key 27 is put in the flat key slot 26. In order to prevent the relative movement between the rotating taper 2 and the changeable cutter arbor 8, screw the fastening screw 23 into the fastening screw hole 24 and press the flat key 27 tightly.

The changeable cutter arbor 8 is mounted in the taper hole 22 of the rotating taper 2 via a screw 83, and the cutter 82 is mounted on the changeable cutter arbor 8 via a fastening bolt 81.

While fine adjusting, rotate the worn 4, so that the turbine 3 drives the rotating taper 2 to rotate due to the engagement between the worn 4 and turbine 3, and further drives the changeable cutter arbor 8 to rotate, so as to fine adjust the cutter tip of the cutter 82.

In this example, when the worn 4 rotates one circle, the feed amount changes 0.25 mm. The dial 7 for indicating the feed amount on the worn 4 has 50 indicating lines marked thereon, and each indicating line indicates that the feed amount changes 0.005 mm. Due to the small range of the fine adjustment (about 2 mm), large position shift can be achieved by adjusting the position of the cutter 82 and a plurality of changeable cutter arbor 8 of different sizes.

### EXAMPLE 6

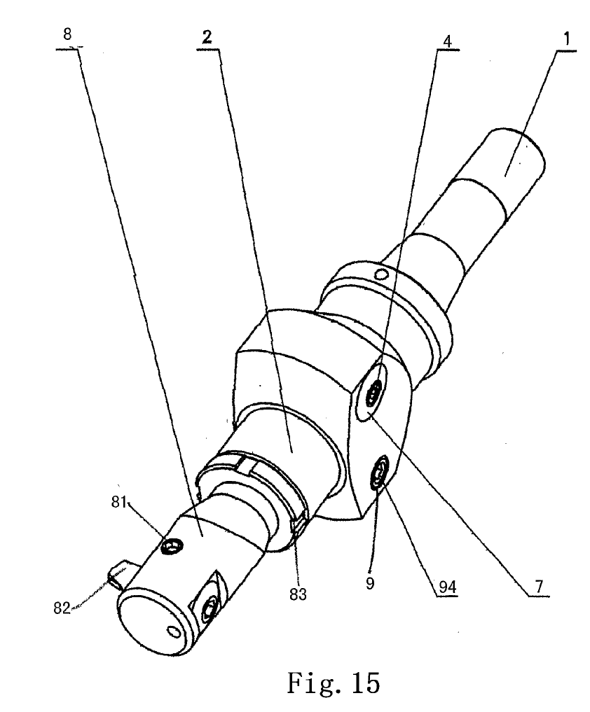

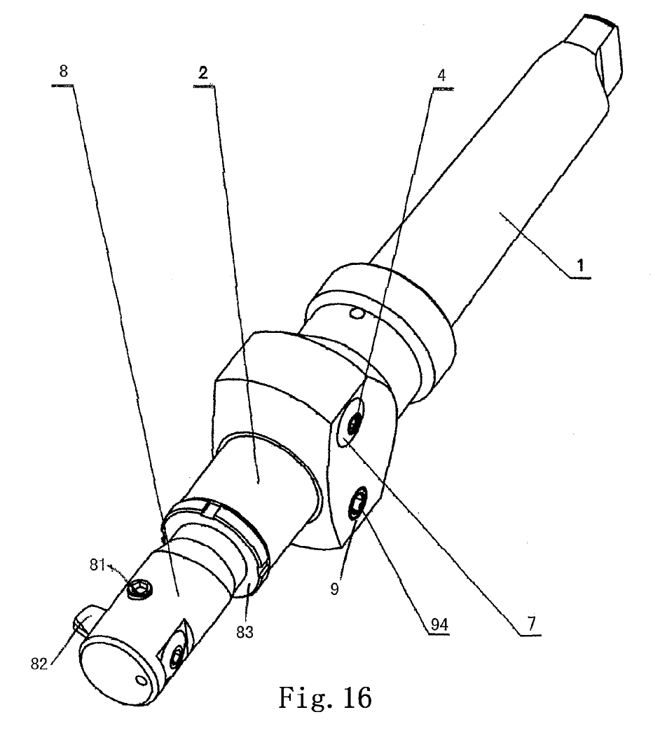

Referring to FIG. 15, this example is applied to a milling machine. The perspective view is shown in FIG. 16. The taper shank of the cutter bar is engaged with the taper hole of the axis of the milling machine (7:24). The internal structures and the relationship of each element are same to the example 5.

### EXAMPLE 7

Referring to FIG. 16, this example is applied to a drilling and boring machine. The perspective view is shown in FIG. 16. The taper shank of the cutter bar 1 is engaged with the taper hole at the main axis of the drilling and boring machine (morse taper). The internal structures and the relationship of each element are same to the example 5.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for fine adjusting feed amount of a boring cutter, comprising a step of:
rotating a cutter bar taking an axis of said cutter bar as center of circle for driving a cutter tip to rotate taking a center of circle that has an offset e apart from said axis of said cutter bar, so as to adjust a feed amount of said boring cutter.

2. The method for fine adjusting feed amount of a boring cutter, as recited in claim 1, wherein said offset e is obtained by designing an Archimedes spiral taking said axis center of the cutter bar as center and replacing said Archimedes spiral with an approximate arch α, and said offset between a center of said arch α and said axis center of said cutter bar is e.

3. The method for fine adjusting feed amount of a boring cutter, as recited in claim 1, wherein said offset e is a real number.

4. An adjusting device for adjusting feed amount of a boring cutter, comprising:
a cutter bar having a first taper hole therein with an axis that is apart from an axis of said cutter bar;
a rotating taper, engaged with said taper hole of said cutter bar, having a second taper hole provided therein; and
a driving mechanism mounted on said cutter bar and driving said rotating taper to drive a changeable cutter arbor to rotate so as to adjust feed amount of said cutter.

5. The adjusting device for adjusting feed amount of a boring cutter, as recited in claim 4, wherein said driving mechanism is a turbine and worn transmission mechanism.

6. The adjusting device for adjusting feed amount of a boring cutter, as recited in claim 5, wherein a dial for indicating feed amount of cutter changing in a rotary manner is provided on said worn of said turbine and worn transmission mechanism, so as to obtain accurate feed amount value.

7. The adjusting device for adjusting feed amount of a boring cutter, as recited in claim 4, wherein said cutter bar has a first eccentric taper hole apart from an axis of said cutter bar, wherein in the first eccentric taper hole, a rotating taper is provided between a side cover threadedly connected to said cutter bar and a resilient element, wherein said rotating taper has a second eccentric hole apart from an axis of said rotating taper, wherein a changeable cutter arbor is provided in said second eccentric hole of said rotating taper, and a cutter is mounted on a front of said changeable cutter arbor via a fastening screw; a turbine is mounted on said rotating taper, and a worn is mounted on said cutter bar via a pair of bearing side covers and is engaged with said turbine so as to drive said rotating taper to rotate, wherein said bearing side cover on one side of said worn has 20 indicating lines marked thereon, and each indicating line indicates that a feed amount changes 0.025 mm.

8. The adjusting device for adjusting feed amount of a boring cutter, as recited in claim 4, wherein in said eccentric taper hole of said cutter bar, said rotating taper having a taper hole therein is mounted between a resilient element and a fastening cover that is threadedly connected with said cutter bar, wherein an axis of said taper hole is coincidence with an axis of said rotating taper; an incomplete turbine of a turbine and worn mechanism is mounted on said rotating taper, wherein an worn is mounted in an worn hole of said cutter bar via a bearing, a bearing fastener and a bearing fastener with cover, and said worn is engaged with said incomplete turbine; a dial for indicating feed amount is fixed on one side of said worn and can rotate with said worn; a first fastener and a second fastener of a fastening unit are fastened in a fastening hole of said cutter bar via a gasket and a fastening bolt; a fastening arch matched with an outer taper arch of said rotating taper is provided on said first fastener and said second fastener respectively; a changeable cutter arbor is mounted in said taper hole of said rotating taper via a screw, and a cutter is mounted on said changeable cutter arbor via a fastening bolt.

9. The adjusting device for adjusting feed amount of a boring cutter, as recited in claim 4, wherein in said eccentric taper hole of said cutter bar, said rotating taper having a taper hole therein is mounted between a resilient element and a fastening cover that is threadedly connected with said cutter bar, wherein an axis of said taper hole is coincidence with an axis of said rotating taper; an incomplete turbine of a turbine and worn mechanism is mounted on said rotating taper, wherein an worn is mounted in an worn hole of said cutter bar via a bearing, a bearing fastener and a bearing fastener with cover, and said worn is engaged with said incomplete turbine; a dial for indicating feed amount is fixed on one side of said worn and can rotate with said worn; a first fastener and a second fastener of a fastening unit are fastened in a fastening hole of said cutter bar via a gasket and a fastening bolt; a fastening arch matched with an outer taper arch of said rotating taper is provided on said first fastener and said second fastener respectively; a cutter is threadedly connected with a changeable cutter arbor; a dial for indicating linear feed amount is provided at a threaded connection position of said changeable cutter arbor, wherein said cutter has indicating lines stamped thereon.

10. The adjusting device for adjusting feed amount of a boring cutter, as recited in claim 9, wherein said changeable cutter arbor adjusts a feed amount via a thread thereon; an angle between an axis of said thread and an axis of said changeable cutter arbor is 53 degree and 8 minute; a thread pitch of said thread is 1 mm; said dial for indicating linear feed amount is equally divided to 20 parts, and an indicating precision is 0.04 mm.

11. The adjusting device for adjusting feed amount of a boring cutter, as recited in claim 4, an eccentric hole is provided in said cutter bar, wherein an axis of said eccentric hole is apart from an axis of said cutter bar; a pressure adjusting screw hole for mounting a pressure adjusting screw and a fastening screw hole for mounting a fastening screw are respectively provided on said cutter bar; an incomplete turbine, a taper hole for mounting a changeable cutter arbor, an optical hole for receiving a pressure adjusting screw, and a fastening screw hole for mounting a fastening screw are provided on said rotating taper that is engaged with said eccentric taper hole; a screw head hole for receiving a head of said pressure adjusting screw is provided at an end of a changeable cutter arbor; a worn of a turbine and worn mechanism is mounted in a worn hole of said cutter bar via a bearing, a bearing fastener and a bearing fastener with cover, wherein said worn is engaged with said incomplete turbine; a dial for indicating feed amount is fixed on one side of said worn and can rotate with said worn; a first fastener and a second fastener of a fastening unit are fastened in a fastening hole of said cutter bar via a gasket and a fastening bolt; a fastening arch matched with an outer taper arch of said rotating taper is provided on said first fastener and said second fastener respectively; a changeable cutter arbor is mounted in said taper hole of said rotating taper via a screw, and a cutter is mounted on said changeable cutter arbor via a fastening bolt; a disk spring unit comprises a disk spring, a pressure adjusting screw, and a fastening screw that is mounted on a bottom of said taper hole of said rotating taper; a head of said pressure adjusting screw is inserted into a head hole of said changeable cutter arbor; a threaded segment passes through a disk spring and said optical hole at a bottom of said rotating taper and is being inserted into said pressure adjusting screw hole of said cutter bar; press said disk spring tightly, so as to keep said rotating taper rotating inside said cutter bar without shifting an axis of said rotating taper; fasten said fastening screw in said fastening screw hole of said cutter bar, and press said pressure adjusting screw so as to prevent said pressure adjusting screw from loose; a flat key slot is provided on said rotating taper, and a flat key is put in said flat key slot; in order to prevent a relative movement between said rotating taper and said changeable cutter arbor, screw said fastening screw into said fastening screw hole and press said flat key tightly; a changeable cutter arbor is mounted in said taper hole of said rotating taper via a screw, and a cutter is mounted on said changeable cutter arbor via a fastening bolt.
